(19) United States
(12) Patent Application Publication
(10) Pub. No.: US 2020/0282524 A1
(43) Pub. Date: Sep. 10, 2020

(54) Pliers Tool

(71) Applicant: Paul Joseph Soli, Hazel Park, MI (US)

(72) Inventor: Paul Joseph Soli, Hazel Park, MI (US)

(21) Appl. No.: 16/810,730

(22) Filed: Mar. 5, 2020

Related U.S. Application Data
(60) Provisional application No. 62/813,929, filed on Mar. 5, 2019.

(51) Int. Cl. B25B 7/22; B25B 7/14

(52) U.S. Cl. CPC B25B 7/22; B25B 7/14

(57) ABSTRACT

A pliers tool (01) includes a hosting pliers that attaches to and manipulates a separate, principal use pliers (02). The hosting pliers having a first retainer (45a) connected to a ply assembly. The first retainer (45a) being configured to retain a handle of the principal use pliers (02) to a ply assembly of the hosting pliers/pliers tool (01).

### CROSS-REFERENCES TO RELATED APPLICATIONS

This patent application claims priority to U.S. Provisional Patent Application Ser. No. 62/813,929, filed Mar. 5, 2019, which is incorporated herein by reference in its entirety.

### BACKGROUND

The present disclosure relates to an adaptative, multi-functional pliers enhancing tool.

Hand-held pliers include handles that lead to or are connected to jaws that may be used in various applications such as: securing a workpiece (as a vice), turning fasteners or pipes, or cutting various materials. Each particular application may present challenges to the user that can be difficult to overcome such as: insufficient transfer of force from the handles (where force is applied) to the jaws directly engaging a workpiece, unsuitable overall length of the pliers for the application, grip sustainability on the handles, and ergonomic issues or obstructions contributed to by the pliers' handle orientation relative to the user.

### SUMMARY

Disclosed is a pliers tool arranged to attach as a hosting pliers and may manipulate a separate, principal use pliers. The hosting pliers are provided with a first receiver that is connected to a first ply. The first receiver is configured to receive a handle of a principal use pliers.

Also disclosed is a pliers tool having a hosting pliers provided with a first retainer connected to or as part of a ply or its connective hardware. The first retainer being configured to retain a handle of a principal use pliers to a ply of the hosting pliers.

Further disclosed is a pressure loading box assembly (PLBA). The PLBA is arranged to facilitate the dynamic requirements of both a receiver and a retainer as part of the pliers tool such that this specific arrangement of moving and non-moving parts enables a receiver and an interactive pressure band to be forcefully guided toward each other such that they create a movement-compensating vice/retainer for a prominent protrusion such as a handle of a principal use pliers. PLBA having the capacity to function beneficially in other considerable applications separate from the pliers tool.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is an isometric view of the pliers tool.

FIG. 2 is a side perspective of the pliers tool in a first position.

FIG. 3 is a side perspective of the pliers tool wherein receiver assemblies and principal use pliers are shown holding a wire.

FIG. 4 is a side perspective of the frontward ply assemblies with receivers orientated.

FIG. 5 is an isometric view of the pliers tool in a first position.

FIG. 6 is a side perspective of the pliers tool hosting a principal use pliers, both tools in first positions.

FIG. 7 is a side perspective of the pliers tool hosting a principal use pliers, both tools in second positions.

FIG. 8 is a top perspective of the pliers tool.

FIG. 9 is a rear perspective of the rearward ply assemblies of the pliers tool.

FIG. 10 is a side profile of the pliers tool hosting a principal use pliers wherein the second receiver assembly of the pliers tool has been transposed to the second jaw arm to accommodate the larger principal use pliers.

FIG. 11 is a side profile of the pliers tool's first frontward ply assembly showing an adjustable jaw arm and demonstrating the compensatory capacity of the pressure loading box assembly (PLBA).

FIG. 12 is a side profile of the pliers tool showing an adjustable jaw arm.

FIG. 13 is a front perspective of the pliers tool being held by a hand, PLBA in second position.

FIG. 14 is a front perspective of the first jaw of the pliers tool being held by a hand, PLBA in first position.

FIG. 15 is a view of a pivot/swivel mounting plate.

FIG. 16 is an isometric view of the PLBA in second position.

FIG. 17 is a top perspective of the PLBA.

FIG. 18 is a disassembled view of a second receiver assembly with attaching hardware, and a pivot/swivel mounting plate.

FIG. 19 is a disassembled view of the PLBA with attaching hardware, and a pivot/swivel mounting plate.

### DETAILED DESCRIPTION

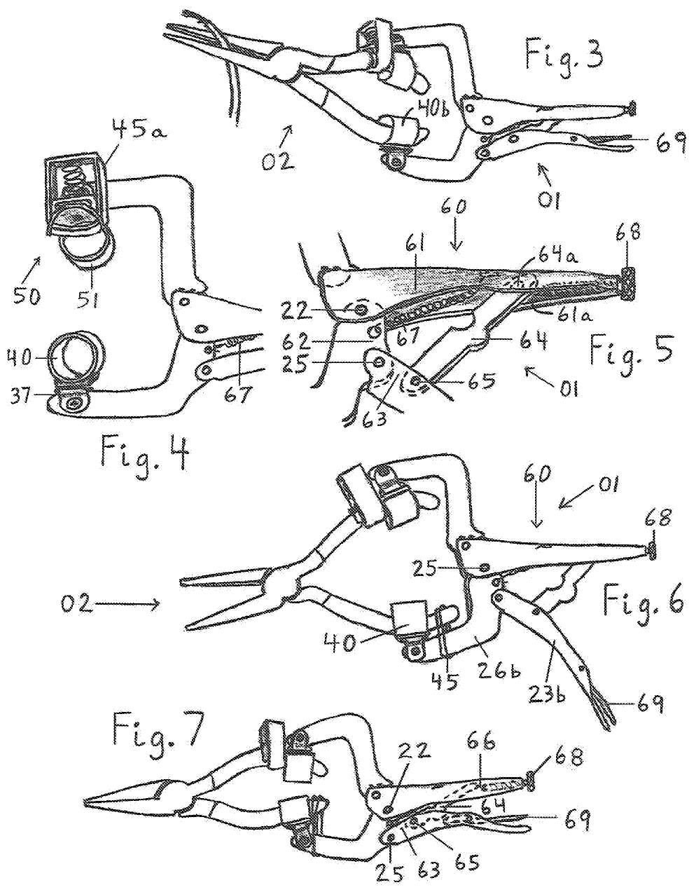

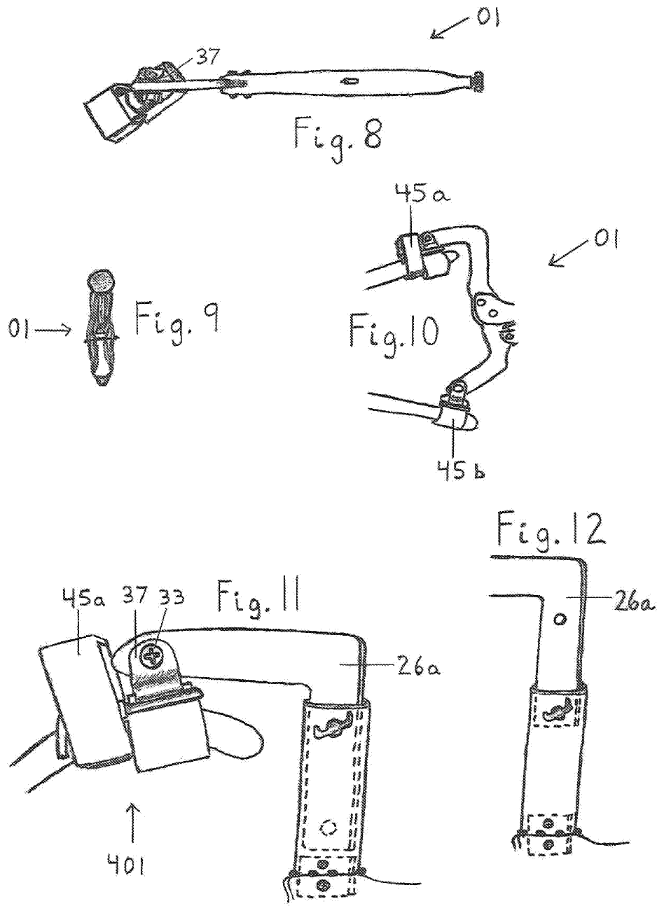

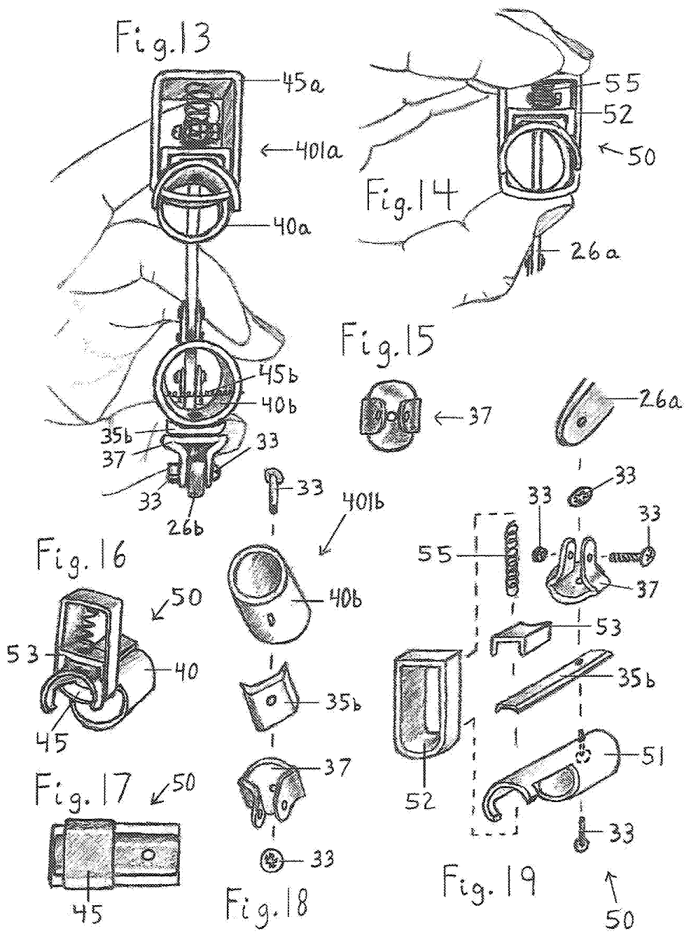

Referring now to the figures, where the invention will be described with reference to specific embodiments, without limiting same, FIG. 3 illustrates a principal use pliers (02). The principal use pliers (02) may be used as a stand-alone tool consisting of two jaws, hingedly or otherwise movably connected to two handles. The principal use pliers (02) may be employed to enable the manipulation of a workpiece (any given construction, mechanical, medical, hobby, or other materials to be manipulated such as fasteners, and various fabrication materials) without direct engagement with an operator's hands.

The principal use pliers (02) may provide a fixed ratio between the force applied by the user's hand(s) and the resulting force at the jaws of the principal use pliers (02) thereby rendering the user of the principal use pliers (02) unable to exert a minimum threshold of force to manipulate materials as desired such as when cutting or gripping stubborn fasteners. Factors contributing to the problem of insufficient force for the task may include the user having reduced physical strength, muscle fatigue, injury, spatial limitations interfering with the user's grip, or other limiting conditions.

The principal use pliers (02) may have a fixed length of a handle, which may reduce the amount of force applied to the jaws. The opposite could also be true in that the point of comfortable grip on the handles of a principal use pliers (02) may be inconveniently farther from the jaws than desirable, thereby producing a greater amount of force at the jaws than desired.

The principal use pliers (02) may have a fixed orientation of the handles to the jaws, which may reduce accessibility of the handle by a user of the principal use pliers (02) during specific work such as when working around a physical obstruction in a confined space or when working overhead.

The principal use pliers (02) may not include a feature to lock the principal use pliers (02) onto a workpiece thereby preventing its user from applying sustained force to achieve tasks such as clamping or propping up a workpiece for bonding or joining operations such as soldering or bead-making, or even suturing or other applications.

The principal use pliers (02) may have a fixed length, which at the handles may provide an insufficient lever arm for torque applications such that its user cannot sufficiently leverage the material in the jaws such as when trying to turn a fastener or bend sheet metal or other materials. Furthermore, a fixed length of the principal use pliers (02) may lead to the principal use pliers (02) being too short or too long for the spatial limitations when held in the user's hand.

The principal use pliers (02) may have a fixed ratio of movement between its handles and the corresponding movement at its jaws. This relationship may prevent the application of force at the jaws that reaches (but does not exceed) a desired threshold in certain applications such as press-fitting or cracking a walnut's shell without damaging the meat.

The principal use pliers (02) may have an uncomfortable, damaged, or non-insulated handle, which may limit its mechanical or safe usefulness.

As shown in FIG. 3, the pliers tool (01) may be arranged to attach to a principal use pliers (02) to overcome the above identified limitations as well as other limitations associated with principal use pliers (02).

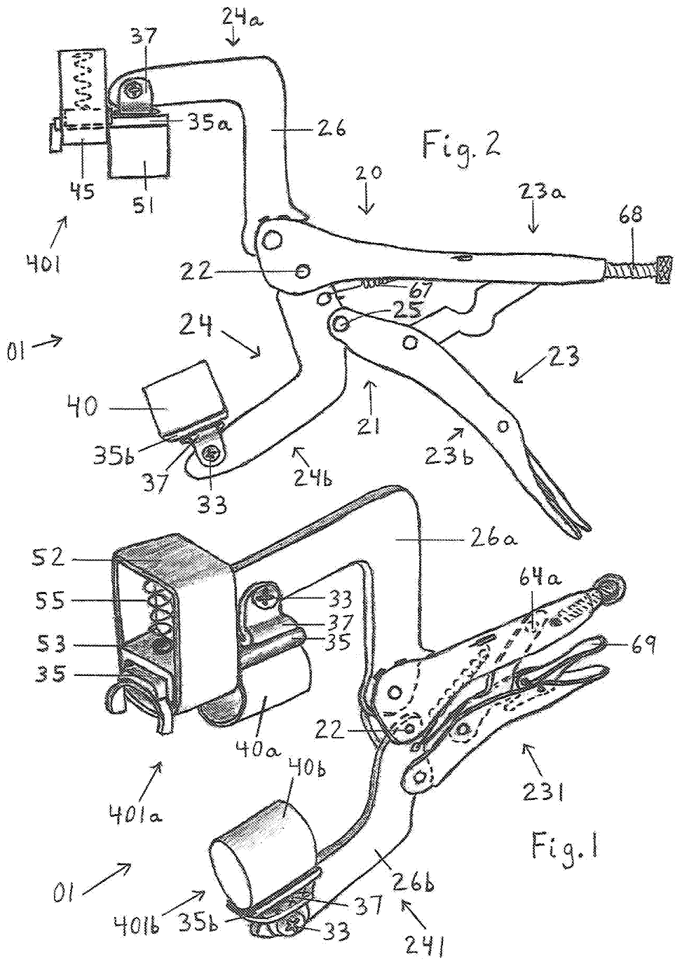

As shown in FIGS. 1-7, the pliers tool (01) may: create greater force as desired by capitalizing on the force multiplying four-bar linkage assembly (FBLA) (60), which may be incorporated with the pliers tool (01); create greater force or less force through mechanical advantage when attaching to different points on the handles of the principal uses pliers (02); provide dynamic handle/jaw orientation options with bi-directional pivot/swivel joints through pivot/swivel mounting plates (37); enable the locking of the handle/jaw into a plurality of positions to manipulate or support a workpiece as facilitated by the over-center condition of a four-bar linkage assembly (FBLA) (60), which may be incorporated into the pliers tool (01); enable greater or lesser torque application/leverage capabilities by creating an overall longer or shorter tool assembly by changing the insertion depths/attachment points of the handles of the principal use pliers (02) within the receivers (40)/retainers (45) of the pliers tool (01); become an overall longer assembly or attach at a point on the handles of the principal use pliers (02) that is inaccessible to reach with a bare hand or too difficult for a bare hand to apply substantial force; deliver more steady or controllable force to the jaws of a principal use pliers (02) as facilitated by a four-bar linkage assembly (FBLA) (60), which may be incorporated into the pliers tool (01), since an FBLA (60) in the pliers tool (01) alters the ratio of movement between the handles of the pliers tool (01) where force is applied by the user and the resulting movement at the working end of the tool assembly [the jaws of the principal use pliers (02)] such that the handles of the principal use pliers (02) where force is applied by the pliers tool (01) move less in relationship to the handles of the pliers tool (01) where force is applied by its user thereby compounding and modulating the force applied to the jaws of the principal use pliers (02) when compared to the use of principal use pliers (02) as a stand-alone tool; provide solutions to an uncomfortable or damaged handle of a principal use pliers (02) by allowing its user to bypass direct engagement with the handles of a principal use pliers (02).

Furthermore, the pliers tool (01) may provide solutions to a non-insulated handle of a principal use pliers (02) by possibly insulating the parts of the pliers tool (01) which may directly contact its user. Similarly, various exposed parts of the pliers tool (01) may be insulated to prevent conduction between such parts and their surroundings, which could cause problems such as arcing, and/or damage to electronics.

A pliers tool (01) may be used to control a principal use pliers (02), and some of its methods of use are described in conjunction with FIGS. 1-19.

As shown in FIG. 2, the pliers tool (01) may include ply assemblies comprising a first ply (20) and a second ply (21). The first ply (20) and the second ply (21) may be generally linear, arcuate or sinuous members or the like that are hingedly or pivotally connected to each other through a hinge(s) or pivot member(s). The first ply (20) and/or second ply (21) may be arranged as separate members connected to each other. The first ply (20) or the second ply (21) may be distinguished from each other by their position relative to said hinge(s) or pivot member(s), such as a primary main hinge (22) [e.g. above or below the primary main hinge (22)]. The first ply (20) and the second ply (21) are movably connected to each other, such as by hinged connection(s) through a primary main hinge (22) that extends at least partially through both the first ply (20) and the second ply (21) as needed for attaching the two plies to each other.

As shown also in FIG. 2, the pliers tool (01) may further include a rearward ply (23), graspable as a handle, or a frontward ply (24), having a jaw arm (26), generally distinguishable from each other by extending from opposing sides of a movable connection(s), such as hinged connection(s) through a primary main hinge (22) or secondary main hinge (25) that extends at least partially through both the frontward ply (24) and the rearward ply (23) as needed for attachment. Frontward ply (24) and/or rearward ply (23) may be arranged as separate sections connected to each other. Rearward ply (23) extending from an end of the pliers tool (01) having a handle. Frontward ply (24) extending from an end of the pliers tool (01) having a jaw arm (26).

As shown in FIG. 2, any ply may or may not be a continuous member or section, and any ply may transition into any other ply as a continuous member or as separated members or sections, such as a first rearward ply (23a) transitioning into a second frontward ply (24b). A portion of any ply may be connected to any other ply, such as a first rearward ply (23a) being connected to a second rearward ply (23b).

As shown in FIGS. 1, 2, 6 & 7, the pliers tool (01) and principal use pliers (02) may be movable between at least two positions, a first position (more open) or a second position (more closed). However, the pliers tool (01) and principal use pliers (02) may be movable between a range of positions.

As shown in FIGS. 1, 2, 5, 6 & 7, a four-bar linkage assembly (FBLA) (60) having FBLA first ply bar (61) as a section of first rearward ply (23a) assembly having at one end a fixed, primary main hinge (22) attaching it to second jaw arm (26b) and at the other end an FBLA adjustable hinge (66) point such that one end of FBLA rearward bar (64) is forced by FBLA tension spring (67) to slide internally along a FBLA slotted tubular section (61a) of FBLA first ply bar (61) until it engages and is stopped by FBLA adjustment screw (68) end, which is threaded into rearward end of first rearward ply (23a).

As shown in FIGS. 5 & 7, FBLA adjustable hinge (66) end of FBLA rearward bar (64) forcefully held against end of FBLA adjustment screw (68) by FBLA tension spring (67) and retained within FBLA first ply bar (61) by FBLA rear bar raised protrusion (64a) at end of FBLA rearward bar (64) so that FBLA rearward bar (64) cannot fall out of FBLA slotted tubular section (61a) of FBLA first ply bar (61).

FBLA rear bar raised protrusion (64a) large enough to retain end of FBLA rearward bar (64) within FBLA first ply bar (61) and small/smooth enough to fit and move freely along FBLA slotted tubular section (61a) of FBLA first ply bar (61) as governed by the FBLA adjustment screw (68).

As shown in FIG. 5, FBLA tension spring (67) attaching to FBLA frontward bar (62) and to FBLA first ply bar (61) or elsewhere to create tension within FBLA (60).

FBLA frontward bar (62) as an intermediate section of second frontward ply (24b) having at both ends fixed hinges, one at primary main hinge (22) attaching it to first ply (20), and one at secondary main hinge (25) attaching it to second rearward ply (23b).

As shown in FIGS. 5 & 6, FBLA second ply bar (63) as a section of second rearward ply (23b) having at both ends fixed hinges, one at secondary main hinge (25) attaching it to second jaw arm (26b) and one at FBLA over-center hinge (65) attaching it to an end of FBLA rearward bar (64).

FBLA rearward bar (64) having a fixed hinge attaching one end to an end of FBLA second ply bar (63) and the other end engaging the end of FBLA adjustment screw (68) within FBLA slotted tubular section (61a) to create the aforementioned FBLA adjustable hinge (66) within FBLA first ply bar (61).

As shown in FIGS. 1, 3, 6 & 7, FBLA release lever (69) attached to second rearward ply (23b), or elsewhere, for overcoming the over-center condition as part of the FBLA (60).

FBLA second ply bar (63) and FBLA rearward bar (64) may become parallel under load if the jaws of the pliers tool (01) are being closed against an opposing force and FBLA adjustment screw (68) is positioned to permit parallel sections under load. If these two sections become parallel (making a single, segmented linear section) under load and are then forced to break parallel on the opposite side from where they started, they can become locked into position if their continued movement to the opposite side from where they started is restricted just “over-center” or beyond parallel. At this point, the force of the workpiece once working to separate the jaws of the pliers tool (01) becomes rerouted such that it keeps the jaws of the pliers tool (01) closed. FBLA over-center hinge (65) refers to being “over-center” with respect to secondary main hinge (25) and FBLA adjustment hinge (66). This beyond parallel, over-center condition will be stopped slightly over-center when curved section of FBLA rearward bar (64) presses into frontward end of FBLA release lever (69), and the force against one end of said lever will pop the other side up into the ready position. Once ready, squeezing rearward end of FBLA release lever (69) against its respective handle creates a strong leveraging force to separate the handles and disengage over-center condition and release the locking feature.

Over-center condition could also be released at one or more different release points through various methods (if necessary) or by simply separating the handles forcibly.

As shown in FIGS. 1, 2 & 6, the pliers tool (01) may comprise a first frontward ply (24a) and second frontward ply (24b) (together forming the jaws), each comprising a jaw arm (26) extending from a primary main hinge (22) or secondary main hinge (25) and leading to (and supporting) a receiver (40) to receive and retainer (45) to retain a handle of a principal use pliers (02) at the frontward end of both the first jaw arm (26a) and second jaw arm (26b).

As shown in FIGS. 1, 2, 11, 18 & 19, first frontward ply (24a) (first jaw) may further comprise: first jaw arm (26a), first receiver (40a), first retainer (45a), first receiver attaching plate (35a), pivot/swivel mounting plate (P/SMP) (37), and attaching hardware (33). Attaching hardware (33) providing as needed any nuts/bolts, washers, studs, push washers, spring washers, rivets or the like to fasten any parts or assemblies included with the pliers tool (01).

As shown in FIGS. 1, 13, 16, 17 & 19, first receiver (40a) extends from or is integrally formed with a portion of first jaw arm (26a), having part(s) that directly contact a handle of a principal use pliers (02). The hosted principal use pliers' (02) handles may each be held/received by and retained in its respective receiver (40) by various methods including the use of hook and loop fasteners, sections of tubing, adhesives, rubber bands and other principals working as either a receiver (40), a retainer (45) or both, such as the disclosed pressure loading box assembly (PLBA) (50) which may be incorporated as a first receiver assembly (401a) of the pliers tool (01) and is distinctly claimed in the claims section of the specification.

As shown in FIGS. 2 & 4, PLBA receiver (51) may generally be a hollow or open member of PLBA (50).

First receiver (40a) and first retainer (45a) integral to PLBA (50).

As shown in FIGS. 14, 16 & 19, PLBA (50) comprising a PLBA spring (55) or other pressure-exerting means, PLBA receiver (51), and a PLBA band (52) as a retainer (45), which is a part having a guided closing or retaining movement towards a prominent protrusion (could be anything) positioned between it and the PBLA receiver (51). PLBA band (52) interior walls guided by the external surface of PLBA receiver (51) and/or PLBA band guide (53) if necessary.

PLBA band guide (53) to assist travel of PLBA band (52) may be present within PLBA (50), resting on top of first receiver attaching plate (35a), which uses attaching hardware (33) or bonds (with an adhesive) to PLBA (50). First receiver attaching plate (35a) further attaches to pivot/swivel mounting plate (P/SMP) (37) such that the mating surfaces between first receiver attaching plate (35a) and pivot/swivel mounting plate (37) allow for swiveling motion of PLBA (50) with respect to pliers tool (01) to which it is attached.

As shown in FIGS. 1 & 2, attachment and mobility of first and second, receivers (40)/receiver assemblies (401) may be enabled by pivot/swivel mounting plates (P/SMP) (37), which may be used by the pliers tool (01) where each of the first and second, receivers (40) may attach to their respective frontward plies (24). P/SMP (37) may attach hingedly with attaching hardware (33) to an end of a jaw arm (26) and then to a receiver attaching plate (35) which may attach to/support a receiver (40)/receiver assembly (401).

P/SMP (37) may facilitate secure adjustments in the orientation of a principal use pliers (02) to the pliers tool (01) and its user while being hosted by the pliers tool (01) by allowing the handles of the hosted pliers to swivel at the mating or junction of P/SMP (37) and receiver attaching plate (35) laterally on a rotation axis away from the axis occupied by the handles of the pliers tool (01). Secure aspect of mating may be achieved by means such as having friction-producing knurling or offset ridges and valleys on opposing surfaces positioned in opposition to one another so as to allow for a mating of ridges and valleys in specific positions.

Pivot/swivel mounting plate (P/SMP) (37) hinged attachment to jaw arm (26) allows a handle of a hosted principal use pliers (02) to pivot forward and rearward to the pliers tool (01) on an axis/plane they may share while also allowing the principal use pliers (02) to swivel through the aforementioned rotation axis, separate from the plane capable of being shared by both handle sets.

P/SMP (37) pivoting allowance as the primary facilitators of movement as needed for the normal operation (opening and closing) of the handles of a principal use pliers (02) hosted by the pliers tool (01) by allowing the hosted pliers' handles to be held securely throughout a range of pivoting or teetering in two directions, sharing the axis parallel to its handles with each pivot of each jaw independently accommodating variations as needed.

P/SMP (37) swiveling allowance as secondary movements allowing for greater versatility and functionality of pliers tool (01).

PLBA band guide (53), if necessary, acts as a guide separate from guiding support which may be provided by receiver (40) itself. PLBA band (52) may crown the first receiver attaching plate (35a) within PLBA (50) above the gateway providing entry into the assembly as needed by a handle of the principal use pliers (02) to be hosted by the pliers tool (01).

First receiver attaching plate (35a) as an attachment point, if necessary, to a tool, other assembly or workpiece separate from the pliers tool (01).

PLBA band guide (53) and first receiver attaching plate (35a) may or may not be necessary for some applications outside of the pliers tool (01), or their presence may be integral to PLBA receiver (51).

PLBA spring (55) forces PLBA band (52) towards PLBA receiver (51) so as to retain by pinning a prominent protrusion positioned in between them. PLBA (50) allowing a prominent protrusion (could be anything) to have movement between PLBA receiver (51) and PLBA band (52) within the assembly without the assembly releasing the prominent protrusion as permitted by secure but somewhat loose construction considered in the relationship between PLBA band (52) and the parts acting to guide PLBA band (52), which is either PLBA receiver (51), PLBA band guide (53), or both. The aforementioned loose construction may be facilitator of compensatory capacity of PLBA (50).

As shown in FIGS. 13 & 14, PLBA (50)/PLBA band (52) in pliers tool (01) may be normally more closed (second position)—see FIG. 13, as pliers tool (01) may use a source of constant force (a compression spring) whereas other PLBA (50) applications may use means such as hydraulics, pneumatics or electro-magnets to create pressure, in which case PLBA (50) could be considered either normally more opened (first position)—see FIG. 14. or normally more closed (second position).

Other constant pressure exerting means within PLBA (50) could include materials such as permanent magnets, or self-recovering materials like certain foams, rubber, or the like.

PLBA band (52) shape designed to retain (but allow some movement of a prominent protrusion (could be anything) received and retained by PLBA (50).

As shown in FIGS. 1 & 4, first retainer (45a), not as a component of PLBA (50), may also only be part of a rearward ply assembly (231) or a frontward ply assembly (241) or shared among ply assemblies/attaching hardware (33).

As shown in FIGS. 1, 2 & 13, second frontward ply (24b) (second jaw) may comprise: second jaw arm (26b), second receiver (40b), second retainer (45b), second receiver attaching plate (35b), pivot/swivel mounting plate (P/SMP) (37), and attaching hardware (33).

As shown in FIGS. 1, 2, 3, 6, 13 & 18, a second receiver (40b) extends from or is integrally formed with a portion of second jaw arm (26b), having part(s) that directly contact a hosted pliers' handle. The hosted principal use pliers' (02) handles may each be held/received by and retained in its respective receiver (40) by various methods including the use of hook and loop fasteners, sections of tubing, adhesives, rubber bands and other principals working as either a receiver (40), a retainer (45) or both.

As shown in FIGS. 1, 2, 13 & 18, a second receiver assembly (401b) having a second receiver (40b) tube, second retainer (45b), a second receiver attaching plate (35b), a pivot/swivel mounting plate (P/SMP) (37), and attaching hardware (33). The second receiver (40b) tube (as only a plain section of tubing) having capabilities to act as both a receiver (40) and friction-fit or loose retainer (45).

As shown in FIGS. 1, 6, 7, 10 & 13, second retainer (45b) also as part of the second frontward ply (24b) (second jaw). Second retainer (45b) may be an elastomeric band such as a rubber band, an inherent friction-fit or loose retainer (45), a spring spanning the opening of the second receiver (40b) tube wherein the spring may extend through or into interior walls of the second receiver (40b) tube such that spring at least partially spans across the second receiver (40b) tube. Second retainer (45b), or first retainer (45a), may also only be part of a rearward ply assembly (231) or a frontward ply assembly (241) or shared among ply assemblies/attaching hardware (33).

As shown in FIGS. 1, 2, 4, 13, 15 & 18, second receiver assembly (401b) may be attached to the second jaw arm (26b) in the same way as the first receiver assembly (401a) by a bi-directional pivot/swivel joint facilitated by P/SMP (37) permitting two different ranges of movement of the second receiver assembly (401b), thereby allowing a handle of a hosted principal use pliers (02) to pivot forward and rearward to the pliers tool (01) on an axis/plane they may share and also allowing the principal use pliers (02) to swivel through a rotation axis separate from the plane capable of being shared by both handle sets.

Each receiver (40) is arranged to support the handles of the principal use pliers (02) and may include the use of: air pressure, pneumatics, hydraulics, an adhesive or similar material, a ball/detent arrangement, a band, a bladder or pressure based mechanism, a bracket, a buckle, a cam mechanism, a channel, a clip, a collapsing shape, a conical shape, a flexible material (such as cloth, foam, plastic, rubber, or metal tie), a groove, a hook, a hook and loop fastener, a lever, a magnet, a malleable material (possibly putty), a nut/bolt arrangement, a pawl/tooth arrangement, a pocket, a post (or other protrusion), a post in hole arrangement, a tie such as rope, a seam, a sleeve, a slot, a snap, a sock, a spring, a sticky substance, a string, a strap, a tab, a textured surface, a threaded post into a tapped hole, a tube, a retaining pin, a variable shape, a vice, or the like as made by synthetic, natural, or combined materials.

Each retainer (45) may be arranged to retain a principal use pliers' (02) handle in its respective jaw with the use of: air pressure, pneumatics, hydraulics, a 4-bar-linkage, an adhesive or similar material, a ball/detent arrangement, a band, a bladder or pressure based mechanism, a bracket, a buckle, a cam mechanism, a channel, a clip, a collapsing shape, a conical shape, a flexible material (such as cloth, foam, plastic, rubber, or metal tie), a groove, a hook, a hook and loop fastener, a lever, a magnet, a malleable material (possibly putty), a nut/bolt arrangement, a pawl/tooth arrangement, a pocket, a post (or other protrusion), a post in hole arrangement, a tie such as rope, a seam, a sleeve, a snap, a slot, a sock, a spring, a sticky substance, a string, a strap, a tab, a textured surface, a threaded post into a tapped hole, a tube, a retaining pin, a variable shape, a vice, or the like as made by synthetic, natural or combined materials.

The pliers tool (01) is arranged to attach to and manipulate a principal use pliers (02) such that the jaws of the pliers tool (01) include receivers (40) that support the handles of many types of pliers commonly used as stand-alone tools/principal use pliers (02), and tools less common (such as in special medical applications).

The hosting pliers/pliers tool (01) having a first ply (20) and a second ply (21) [made up of a rearward ply (23) and a frontward ply (24)] hingedly or otherwise movably connected to each other.

The pliers tool (01) rearward plies (23) comprising handles which may be interconnected by an FBLA rearward bar (64) with hinges [separate from the primary main hinge (22) and secondary main hinge (25)], and other parts and attaching hardware (33) as necessary to facilitate the function of an adjustable (manually) or adjusting (automatically) four bar-linkage assembly (FBLA) (60), the potential for an over-center condition, and the release of said condition.

The jaws/frontward plies (24) of the pliers tool (01) are arranged to hold the handles of other pliers. The jaw arms (26) as part of the frontward plies (24) may be considered non-direct engagement parts (but instead more primarily support or backbone sections) of the two, frontward ply (24) and may extend from a primary main hinge (22) or secondary main hinge (25) of the pliers tool (01) and may be considered parts of the jaws of the pliers tool (01). The jaw arms (26) of the pliers tool (01) may be purposefully shaped, proportioned and orientated to each other in order to allow for a wide-ranging jaw span without unnecessary bulk, thereby making them unimpeded and smoothly permissive of adequate range of motion for a principal use pliers' (02) handles while hosted by the pliers tool (01) such that the handles of the hosted principal use pliers (02) may be operated in a range acceptable for the uses associated with a principal use pliers (02).

The hosting pliers/pliers tool (01) having a first receiver (40a) attached to or as part of a first frontward ply (24a) (first jaw), the first receiver (40a) being configured to receive a handle of a principal use pliers (02).

The hosting pliers/pliers tool (01) having a second receiver (40b) connected to or as part of a second frontward ply (24b) (second jaw). The second receiver (40b) being configured to receive another handle of a principal use pliers (02).

A handle-receiving connection of the pliers tool (01) may be anywhere on the pliers tool (01) or be added to the pliers tool (01) or any other pliers as a separate device. Such parts functioning to enable the utility of the pliers tool (01) may be removable, upgradeable (permitting more than one option) or replaceable.

A first retainer (45a) of the pliers tool (01) which may be connected to or be part of a first frontward ply (24a), the first retainer (45a) being configured to retain a handle of a principal use pliers (02) to the first frontward ply (24a) of the pliers tool (01) such that the first retainer (45a) may be part of the first receiver assembly (401a). A first retainer (45a) which may be part of the disclosed PLBA (50).

A second retainer (45b) of the pliers tool (01) which may be connected to or be part of a second frontward ply (24b), the second retainer (45b) configured to retain another handle of a principal use pliers (02) to the second frontward ply (24b) of the hosting pliers such that the second retainer (45b) may be part of the second receiver (40b).

The pliers tool (01) may include providing a retainer (45) separate from the pliers tool (01) that attaches to the principal use pliers (02) or to either or both ply assemblies of the pliers tool (01) or their hinged or other movable connection(s) to keep a handle of a principal use pliers (02) in its respective receiver (40) during use. Some examples could be a clip that locks onto the end of a handle of a principal use pliers (02) thereby preventing it from falling out of its receiver (40), a long elastic band attaching to both handles of the principal use pliers (02) and then to any point on the tool such as a small hook extending from a primary main hinge (22), or a flexible or rigid wire having a magnet on an end to magnetically retain a handle of a principal use pliers (02), and on the other end having a swiveling attachment to a handle of a principal use pliers (02).

A handle-receiving connection/receiver (40) of the pliers tool (01) [part(s) that may directly contact the handle of a principal use pliers (02)] works in conjunction with (directly or indirectly) a retainer (45) or has a design such that a retainer (45) is part of the receiving connection. A retainer (45) functioning to enable the utility of the pliers tool (01) may be anywhere on the pliers tool (01) or even be added to the pliers tool (01) or any other pliers as a separate device, such as to seat a snug-fitting foam or rubber grommet, gasket, putty or the like retainer (45) onto a handle of a principal use pliers (02) prior to inserting into the pliers tool's (01) receiver (40) and then attaching another, similar functioning retainer (45) on the same handle so as to pin/sandwich the handle on both sides to the receiver (40). A receiver (40) without a fully encompassing handle support could also be used and still support a handle with the aforementioned flexible or tacky materials or the like. A single, somewhat similar functioning retainer (45) could attach to a handle on just one side of the receiver (40) or simply be placed around a handle and then “stuffed” into the receiver (40) to retain a handle of a principal use pliers (02).

The pliers tool's (01) first and second receivers (40) may be: connected to their respective frontward plies (24) by bi-directional pivot/swivel joints as enabled by pivot/swivel mounting plates (37) facilitating a range of motion that a principal use pliers' (02) handles may pass through during use; connected to their respective frontward plies (24) by bi-directional swivel/pivot joints as enabled by pivot/swivel mounting plates (37) allowing the pliers tool (01) to host a principal use pliers (02) in a plurality of orientations to the pliers tool (01) itself and the user; attached by a combination of swivel or hinge points and supportive materials having arrangements or mating surfaces within themselves or their respective plies or jaws that intentionally permit only specific, desired movements while still engaging under load such that they assist in adding to the overall rigidity and/or final locking function (if present) of the pliers tool (01) when in use. These arrangements or mating surfaces can be designed, constructed or machined to be repositionable or even removable (possibly through magnetism) and replaceable in ways so as to limit or restrict certain movements by using concepts such as pin/hole assemblies, ball/detents, or other various friction/non-friction based methods such as having knurling or offset ridges and valleys on opposing surfaces positioned in opposition to one another so as to allow for a mating of ridges and valleys in specific positions.

The pliers tool (01) may include a limiting or lockable pivot/swivel joint functioning similarly to P/SMP (37), or another limiting or lockable compensating/adjustable connection at the interface between receiver (40)/receiver assemblies (401) and jaw arms (26), for example, to temporarily secure (add rigidity to) itself or the combination of itself and a principal use pliers (02) in their desired orientation to each other thereby enhancing or expanding its capabilities before and/or after potentially being locked as by force at the handles into a position by various methods. Methods may include creating a restriction in the movement between the first or second receiver (40) and its respective jaw arm (26) or other location (point or section) of a ply assembly or its hardware by employing the restrictive forces of a magnet, other capable methods, or a combination such as: using a magnet in conjunction with a non-threaded stud (or post) in hole assembly as part of a connection, attaching hardware, or other part of the jaw such that the connection may swivel rotationally or otherwise move across an axis allowing the handles of hosted pliers to deviate laterally or otherwise from the axis occupying the handles of the pliers tool (01). This could include an offset wherein the pliers tool's (01) handles and its jaws may be parallel to one another but no longer sharing the same axis, thereby enabling true multi-axis adjustabilty to the pliers tool (01) when considering this function in conjunction with the dual-axis movement facilitated by P/SMP (50); using a magnet in conjunction with a non-threaded stud (or post) in hole assembly as a part of a receiver (40), hardware or other part of a jaw such that the connection may swivel around to a variety of secondary post in hole arrangements such that all together they allow for a choice among a variety of possible orientations between the pliers tool (01) and the principal use pliers (02) to be quickly and rigidly fixed and then unfixed/repositioned as needed [potentially while hosting a principal use pliers (02)], potentially by forcefully separating a magnetic bond, changing the orientation of the arrangement, and reconnecting the magnetic bond as an example; or the like.

As shown in FIGS. 10, 11 & 12, the pliers tool (01) may incorporate quick and simple, yet sturdy and substantial adjustments in overall jaw capacity or throat depth by transposing a hosted handle receiver (40) (flipping the receiver around the jaw from the inner portion of the jaw to the outer portion of the jaw thereby further separating each of the two receivers (40) from each other, or vice versa). FIG. 10 demonstrating transposed receiver (40) identified as second retainer (45b) as it is performing both receiving and retaining capacities. Shown with first jaw arm (26a) in FIGS. 11 & 12, other adjustments could include overlapping or otherwise adjusting sections (such as with replaceable sections) along a jaw arm (26) length or height to change the length or height (affecting jaw capacity) of the jaw arm (26).

The pliers tool (01) may also utilize a sliding and locking (or other) method by which the overall length of the pliers tool (01) may be adjusted (possibly at the handles) to change its size, shape and force-applying capacities in order to accommodate different uses for various principal use pliers (02).

The combination of the pliers tool (01) and a principal use pliers (02) may enable the pliers tool (01) to: increase the force applied to the handles of a principal use pliers (02) through a force multiplying four-bar linkage assembly (FBLA) (60); increase or decrease the potential net squeezing or clamping force at the jaws of a principal use pliers (02) by changing the insertion depth of the handles of a principal use pliers (02) where they are held by the receivers (40) of the pliers tool (01) to vary a total length/lever arm; change the orientation of a principal use pliers (02) to the pliers tool (01) and its user through the bi-directional pivot/swivel joints in the jaws of the pliers tool (01) which allow for dual-axis movements of its hosted pliers' handles thereby offering more diverse capabilities to its user while working in congested or challenging environments; enable their combination to lock into a plurality of positions to manipulate or support a workpiece as facilitated by the over-center condition of a four-bar linkage assembly (FBLA) (60) which may be incorporated into the pliers tool (01); increase or decrease the potential net leveraging force at the jaws of a principal use pliers (02) by changing the insertion depths/attachment points of the handles of the principal use pliers (02) within the receivers (40) of the pliers tool (01); control an overall longer assembly or attach at a point on the handles of the principal use pliers (02) that is inaccessible to reach with a bare hand or too difficult for a bare hand to apply substantial force; deliver greater potential force while remaining more steady and more controllable at the jaws of a principal use pliers (02) by altering the ratio between the amount of movement applied by the user on the handles of the pliers tool (01) and the amount of movement transferred to the handles of the principal use pliers (02) as permitted by a four-bar linkage assembly (FBLA) (60) which may be in the pliers tool (01); allow its user the benefit of manipulating the handles of the pliers tool (01) which may be more comfortable or in better condition than those of the principal use pliers (02); provide solutions to a non-insulated handle of a principal use pliers (02) by possibly insulating the parts of the pliers tool (01) which may directly contact its user; allow its user the possible benefits of the pliers tool (01) being insulated to prevent conduction with any of its parts which could cause problems such as arcing, and/or damage to electronics; provide its user with an opportunity to focus on new or different aspects of challenging tasks otherwise unconsidered or too difficult to manage by offering its user previously non-existent, potential solutions resulting from a greater variety of options (both simple and complex) than those offered by a stand-alone, principal use pliers (02); provide combined user functionality with a simple, lightweight design with various aids for the user such as purposefully designed, bi-directionally moving receivers (40), a purposefully designed, compensating receiver (40)/retainer (45) as part of the disclosed PLBA (50), and potentially incorporating quick and simple, yet sturdy and substantial adjustments in overall jaw capacity by transposing (flipping/transposing) a receiver (40) on the pliers tool (01) or implementing a sliding and locking mechanism along a jaw arm (26) or handles of the pliers tool (01); maintain its rigidity and strength using durable materials like steel, aluminum, carbon fiber or others in the most demanding places while possibly using plastics or other materials in areas where reasonable.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A pliers tool (01), comprising:
a hosting pliers that is arranged to attach to and manipulate a principal use pliers (02), the hosting pliers having a first receiver (40a) connected to or as part of a first ply (20), the first receiver (40a) being configured to receive a handle of a principal use pliers (02).

2. The pliers tool (01) of claim 1, wherein the hosting pliers further comprising:
a second ply (21) hingedly or otherwise movably connected to the first ply (20); and
a second receiver (40b) connected to or as part of the second ply (21), the second receiver (40b) being configured to receive another handle of a principal use pliers (02).

3. The pliers tool (01) of claim 1, wherein a combination of the hosting pliers and a principal use pliers (02) enable a user to orientate and lock the combination into a plurality of different positions to support a workpiece.

4. A pliers tool (01), comprising:
a hosting pliers that is arranged to attach to and manipulate a principal use pliers (02), the hosting pliers having a first retainer (45a) connected to or provided as part of a ply, the first retainer (45a) being configured to retain a handle of a principal use pliers (02) to a ply of the hosting pliers.

5. The pliers tool (01) of claim 4, wherein the hosting pliers further comprising:
a second ply (21) movably connected to the first ply (20); and
a second retainer (45b) connected to or as part of a second ply (21) or its hardware, the second retainer (45b) configured to retain another handle of a principal use pliers (02) to a ply assembly.

6. The pliers tool (01) of claim 4, wherein a combination of the hosting pliers and the principal use pliers (02) enable a user to orientate the combination into a plurality of different positions to support a workpiece.

7. The pliers tool (01) as enabled by any parts attaching to any tool including the aforementioned pliers tool (01) functioning to enable the utility of the pliers tool (01), whether permanent, removable, upgradeable (permitting more than one option) or replaceable.

8. A pressure loading box assembly (PLBA) (50) having PLBA spring (55) or other pressure-exerting means, PLBA receiver (51), and a PLBA band (52) as a retainer (45) wherein this specific arrangement of moving and non-moving parts enable PLBA receiver (51) and PLBA band (52) to be forcefully guided towards each other such that their construction may result in a movement-compensating vice for a prominent protrusion such as a handle of a principal use pliers (02).
